(19) United States
(12) Patent Application Publication
(10) Pub. No.: US 2026/0313372 A1
(43) Pub. Date: Oct. 8, 2026

(54) AUTHORIZING A NON-SEAMLESS WIRELESS LOCAL AREA NETWORK OFFLOAD ROUTE

(71) Applicant: Lenovo (Singapore) PTE. LTD, Singapore (SG)

(72) Inventors: Genadi Velev, Darmstadt (DE); Apostolis Salkintzis, Athens (GR)

(21) Appl. No.: 18/996,724

(22) PCT Filed: Sep. 12, 2022
(86) PCT No.: PCT/EP2022/075249

§ 371 Date: Jan. 17, 2025

(30) Foreign Application Priority Data
Jul. 19, 2022 (GR) 20220100575

(51) Int. Cl. H04W 12/06; H04W 12/72; H04W 84/12

(52) U.S. Cl. CPC H04W 12/06; H04W 12/72; H04W 84/12

(57) ABSTRACT

Apparatuses, methods, and systems are disclosed for authorizing a NSWO route. One method (800) includes receiving (802), at a first network function, a first request from a second network function. The first request includes a request to perform a device authentication for a device. The method (800) includes determining (804) to perform NSWO route authorization for the device. The method (800) includes transmitting (806) from a second request to a third network function. The second request indicates how to route traffic of the device for NSWO access. The method (800) includes receiving (808) NSWO route authorization information from the third network function. The method (800) includes transmitting (810) the NSWO route authorization information to the second network function.

### FIELD

The subject matter disclosed herein relates generally to wireless communications and more particularly relates to authorizing a NSWO route.

### BACKGROUND

In certain wireless communications networks, multiple services may be used in a wireless system. In such networks, a network device may not know which user devices are authorized for such services.

### BRIEF SUMMARY

Methods for authorizing a NSWO route are disclosed. Apparatuses and systems also perform the functions of the methods. One embodiment of a method includes receiving, at a first network function, a first request from a second network function. The first request includes a request to perform a device authentication for a device. In some embodiments, the method includes determining to perform NSWO route authorization for the device. In certain embodiments, the method includes transmitting a second request to a third network function. The second request indicates how to route traffic of the device for NSWO access. In some embodiments, the method includes receiving NSWO route authorization information from the third network function. In various embodiments, the method includes transmitting the NSWO route authorization information to the second network function.

One apparatus for authorizing a NSWO route includes a first network function. In some embodiments, the apparatus includes a receiver to receive a first request from a second network function. The first request includes a request to perform a device authentication for a device. In various embodiments, the apparatus includes a processor to determine to perform NSWO route authorization for the device. In certain embodiments, the apparatus includes a transmitter to transmit a second request to a third network function. The second request indicates how to route traffic of the device for NSWO access. The receiver further to receive NSWO route authorization information from the third network function, and the transmitter further to transmit the NSWO route authorization information to the second network function.

Another embodiment of a method for authorizing a NSWO route includes storing, at a third network function, information corresponding to subscription data of a device using NSWO access, the subscription data including NSWO route authorization information. In certain embodiments, the method includes receiving a request from a first network function. In various embodiments, the method includes determining to provide the NSWO route authorization information to the first network function. In some embodiments, the method includes transmitting the NSWO route authorization information to the first network function.

Another apparatus for authorizing a NSWO route includes a third network function. In some embodiments, the apparatus includes a processor to store information corresponding to subscription data of a device using NSWO access, the subscription data including NSWO route authorization information. In various embodiments, the apparatus includes a receiver to receive a request from a first network function. The processor further to determine to provide the NSWO route authorization information to the first network function. In certain embodiments, the apparatus includes a transmitter to transmit the NSWO route authorization information to the first network function.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for authorizing a NSWO route;

FIG. 2 is a schematic block diagram illustrating one embodiment of an apparatus that may be used for authorizing a NSWO route;

FIG. 3 is a schematic block diagram illustrating one embodiment of an apparatus that may be used for authorizing a NSWO route;

FIG. 4 is a schematic block diagram illustrating one embodiment of a system having an architecture for non-seamless WLAN offload;

FIG. 5 is a schematic block diagram illustrating one embodiment of a system in which NSWO is supported for a SNPN;

FIG. 6 is a schematic block diagram illustrating one embodiment of a system having communications for NSWO service authorization information;

FIG. 7 is a schematic block diagram illustrating one embodiment of a system having communications for NSWO service authorization information embedded in authentication signaling;

FIG. 8 is a flow chart diagram illustrating one embodiment of a method for authorizing a NSWO route; and

FIG. 9 is a flow chart diagram illustrating another embodiment of a method for authorizing a NSWO route.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

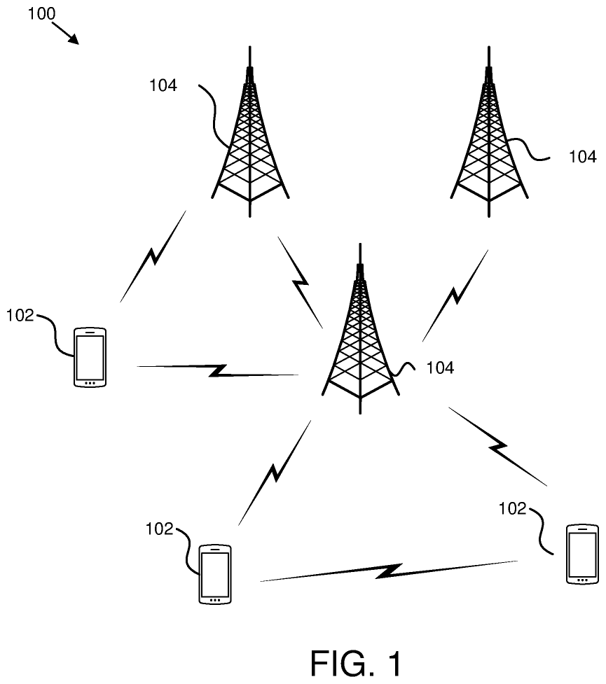

FIG. 1 depicts an embodiment of a wireless communication system 100 for authorizing a NSWO route. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100 In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive a first request from a second network function. The first request includes a request to perform a device authentication for a device. In some embodiments, the network unit 104 may determine to perform NSWO route authorization for the device. In certain embodiments, the network unit 104 may transmit from a second request to a third network function. The second request indicates how to route traffic of the device for NSWO access. In some embodiments the network unit 104 may receive NSWO route authorization information from the third network function. In various embodiments, a network unit 102 may transmit the NSWO route authorization information to the second network function. Accordingly, the network unit 104 may be used for authorizing a NSWO route.

In certain embodiments, a network unit 104 may store information corresponding to subscription data of a device using NSWO access, the subscription data including NSWO route authorization information. In certain embodiments, the network unit 104 may receive a request from a first network function. In various embodiments, the network unit 104 may determine to provide the NSWO route authorization information to the first network function. In some embodiments, the network unit 104 may transmit the NSWO route authorization information to the first network function. Accordingly, the network unit 104 may be used for authorizing a NSWO route.

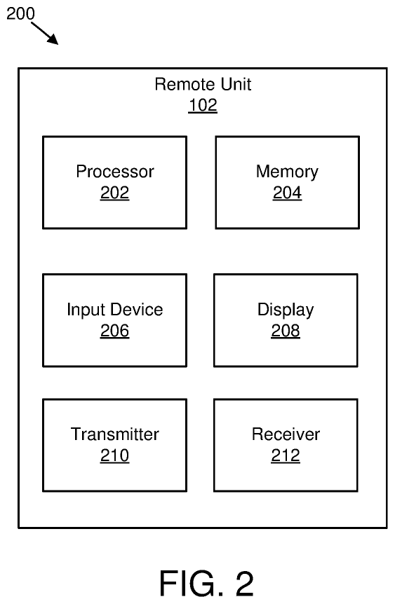

FIG. 2 depicts one embodiment of an apparatus 200 that may be used for authorizing a NSWO route. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

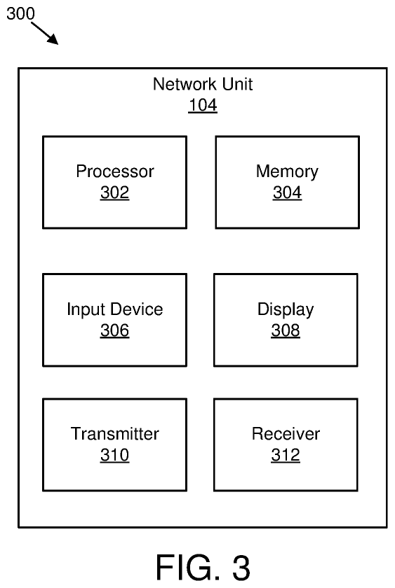

FIG. 3 depicts one embodiment of an apparatus 300 that may be used for authorizing a NSWO route. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 may transmit an encryption key request comprising security capabilities of a user equipment, wherein the encryption key request is for an application layer key. In various embodiments, the receiver 312 may, in response to transmitting the encryption key request, receive an encryption key response comprising a group encryption key.

In certain embodiments, the receiver 312 to receive a first request from a second network function. The first request includes a request to perform a device authentication for a device. In various embodiments, the processor 302 to determine to perform NSWO route authorization for the device. In certain embodiments, the transmitter 310 to transmit a second request to a third network function. The second request indicates how to route traffic of the device for NSWO access. The receiver 312 further to receive NSWO route authorization information from the third network function, and the transmitter 310 further to transmit the NSWO route authorization information to the second network function.

In some embodiments, the processor 302 to store information corresponding to subscription data of a device using NSWO access, the subscription data including NSWO route authorization information. In various embodiments, the receiver 312 to receive a request from a first network function. The processor 302 further to determine to provide the NSWO route authorization information to the first network function. In certain embodiments, the transmitter 310 to transmit the NSWO route authorization information to the first network function.

It should be noted that one or more embodiments described herein may be combined into a single embodiment.

In certain embodiments, there may be a 3GPP specified fifth generation (“5G”) non-seamless WLAN offload (“NSWO”) mechanism which enables a user equipment (“UE”) to access and establish a connection to a WLAN access network using 5G system (“5GS”) credentials while the UE is not registered to the 5GS. For the purpose of NSWO, a network function (“NF”) called non-seamless WLAN offload Function (“NSWOF”) may be used. The WLAN access network uses an SWa interface (interface between an un-trusted non-3GPP Internet protocol (“IP”) access and a 3GPP authentication authorization accounting (“AAA”) server and/or proxy) to request for the NSWOF to authenticate the UE. The NSWOF uses the services of an authentication server function (“AUSF”) (e.g., via an N60 interface) to request the UE authentication for WLAN access.

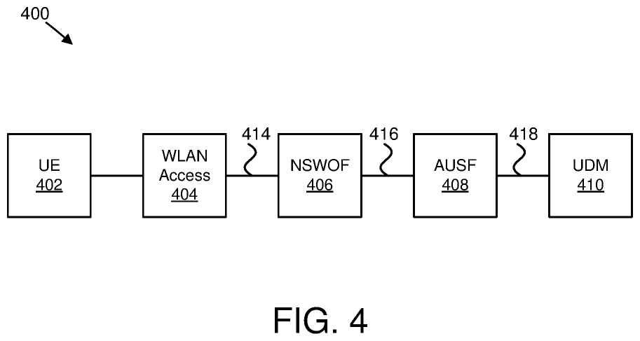

FIG. 4 is a schematic block diagram illustrating one embodiment of a system 400 having an architecture for non-seamless WLAN offload. The system 400 includes a UE 402, WLAN access 404, an NSWOF 406, an AUSF 408, and a UDM 410. An SWa interface 414 is used for communication between the WLAN access 404 and the NSWOF 406, an N60 interface 416 is used for communication between the NSWOF 406 and the AUSF 408, and an N13 interface 418 is used for communication between the AUSF 408 and the UDM 410. After successful authentication, the UE connects to the WLAN access network and obtains IP configuration which allows the UE to access any services offered by the WLAN access network (e.g., Internet access).

In some embodiments, non-public networks (“NPN”) are based on a 5GS and may be deployed to serve private (e.g., non-public) customers and/or services. An NPN may offer a public service (e.g., public telephony service) if the NPN has an agreement with a public land mobile network (“PLMN”).

In various embodiments, NPNs can be deployed in different ways, such as: 1) either as a stand-alone NPN (“SNPN”); or 2) a public network integrated NPN (“PNI-NPN”). Some details of such NPNs are as follows: 1) the PNI-NPNs are deployed via a PLMN by means of dedicated data network names (“DNNs”), or by one or more network slice instances allocated for the NPN-for a PNI-NPN, the UE has a subscription for the PLMN-usually a network customer can request the PLMN to setup a PNI-NPN to use specific customer service-the network customer is called “NPN customer” herein; and 2) the SNPNs may be operated by an NPN operator and may not rely on network functions provided by a PLMN.

In certain embodiments, many enterprises, utilities, educational organizations, governments, or any other organizations requiring its own private campus network may have a WLAN access network (“AN”) deployed in an existing information technology (“IT”) infrastructure. When such organizations would like to deploy an NPN (e.g., SNPN) it may be beneficial if the existing WLAN AN is integrated in the NPN. In one example, the user devices (e.g., UEs) may be configured with the credentials which are used in the SNPN network (e.g., SNPN credentials) and the same credentials can be leveraged for devices accessing SNPN via next generation (“NG”) radio access network (“RAN”) (“NG-RAN”) and 5G core (“5GC”), and non-3GPP access network using NSWOF.

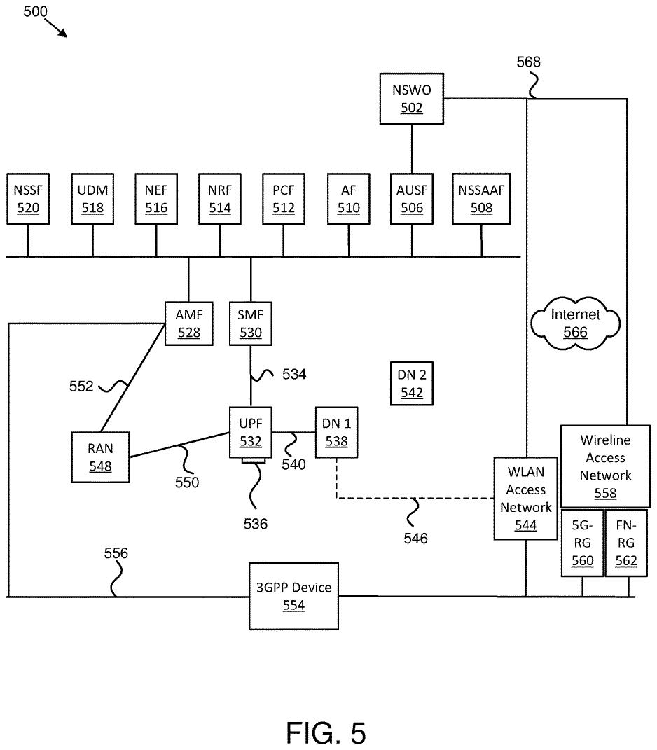

FIG. 5 is a schematic block diagram illustrating one embodiment of a system 500 in which NSWO is supported for a SNPN. In FIG. 5 the non-3GPP access may be via a WLAN AN, a wireline access network using a 5G residential gateway (“5G-RG”), or a wireless access network using a fixed network residential gateway (“FN RG”). The system 500 includes an NSWO 502, an AUSF 506, a network slice secondary authentication and authorization (“NSSAA”) function (“NSSAAF”) 508, an application function (“AF”) 510, a policy control function (“PCF”) 512, a network repository function (“NRF”) 514, a network exposure function (“NEF”) 516, a unified data management (“UDM”) 518, a network slice selection function (“NSSF”) 520, an AMF 528, an SMF 530, a UPF 532 that communicates with the SMF 530 via an N4 interface 534 (the UPF 532 communicates internally using an N9 interface 536), a first data network (“DN 1”) 538 that communicates with the UPF 532 via an N6 interface 540, a second data network (“DN 2”) 542, a WLAN access network 544 that is out of scope 546 with the DN 1 538, a RAN 548 that communicates with the UPF 532 via an N3 interface 550 and communicates with the AMF 528 via an N2 interface 552, a 3GPP device 544 that communicates with the AMF 528 via an N1 interface 556, a wireline access network 558 that uses a 5G-RG 560 and/or an FN-RG 562, and an Internet 566. The NSWO 502 communicates with the WLAN access network 544 and/or the wireless access network 558 using an SWa interface 568.

In various embodiments, the 3GPP device 554 implements the WLAN interface and may be one of the following: 1) a device which does not support N1 functionality, and thus does not implement an NG-RAN access interface, but has SNPN credentials-in one particular example, if legacy (e.g., WLAN equipped devices like notebooks or handhelds) are configured with legacy AAA credentials, the legacy credentials may be inserted in the UDR and/or UDM of the NPN deployment; and 2) a device supporting N1 functionality, but requiring IP connectivity without 5GS registration. It should be noted that “N1 capability” is meant to be the capability of a non-access stratum (“NAS”) protocol (and optionally access stratum for NG-RAN) and procedures required to discover a 3GPP network and perform registration with the 5GS.

In certain embodiments, the access network (e.g., WLAN AN 544 or wireline AN 558) provides access to the same data network (e.g., Internet or enterprise network services) part of the network operator's domain. It should be noted that the network may be an NPN or PLMN network and FIG. 5 shows an embodiment including an SNPN.

In FIG. 5, the SNPN may implement multiple data network (e.g., DN 1 538 and DN 2 542). Some devices may be allowed to access DN 1 538 whereas other devices may be allowed to access DN 2 542. For example, the 3GPP device 554 may be allowed to access DN 1 538, but may not be allowed to access DN 2 542. In addition to accessing DN 1 538, the 3GPP device 554 may be allowed to access the Internet 566 service.

In some embodiments, if there are multiple DNs (e.g., part of the network operator's domain) to access in an operator's network (e.g., PLMN or SNPN) and multiple types of devices and/or subscribers use a non-3GPP AN, it may be determined how the non-3GPP AN knows which services (or data networks or destination IP addresses and/or prefixes) are authorized to be used by a particular device.

In various embodiments, routing of UE traffic in an access network if NSWO access is used is up to implementation of the access network (“AN”). The AN, which may be considered a local AN, may have pre-configured policies and service level agreements with a network operator that indicate which DNNs (e.g., in the operator′ network) are allowed to be accessed by UEs authenticated for NSWO access. In such embodiments, the AN cannot decide which DNNs are allowed on a per device and/or UE basis, as some UEs may have different subscribed services or different access policies than other UEs. In other words, the AN is not able to differentiate that for a first UE a first set of DNNs are allowed, whereas for a second UE a second set of DNNs are allowed.

In certain embodiments, there is a method to determine restrictions for allowed services (e.g., network operator's services, or SNPN services) if a device uses NSWO. The network operator's services may be identified by data network name (“DNN”), service identifier (“ID”), which may be in form of a fully qualified domain name (“FQDN”), or destination IP address or prefix. The service and/or routing restrictions (or service and/or routing permissions) are determined in the NSWOF and send to the WLAN access network as (e.g., allowed destination IP addresses and/or prefixes).

If the identities and credentials used for WLAN authentication are provisioned to a device before an SNPN is deployed, in order to unify the WLAN authentication procedure, it is assumed that the identities and credentials are also provisioned in a UDM/UDR of the SNPN. This may allow use of an NSWO procedure to authenticate the device when the device accesses the WLAN access.

In some embodiments: 1) a subscription repository network function (e.g., UDM, UDR, or internal AAA server) in a network is configured with device credentials for authentication and authorization and with service and/or routing restriction information (or service and/or routing permission information) used if the device accesses the network via non-seamless offload (e.g., without registration to 5GS via N 1 interface)-such service restriction information used for NSWO access can be called NSWO allowed operator DNNs and/or service IDs or NSWO policy and may be configured as a new subscription data type in the UDM/UDR storing the UE's subscription data; 2) the NSWOF determines to trigger the retrieval of service restriction information used for NSWO access during and/or after the NSWO authentication procedure-in one example, the NSWOF triggers the retrieval of service restriction information used for NSWO access after the device is successfully authenticated by the AUSF; and 3) the NSWOF derives the restricted destination IP addresses (e.g., prefixes) which the UE is allowed to access (e.g., in the operator's network). The NSWOF sends this information to the non-3GPP AN via an SWa interface. It should be noted that in some embodiments only subscriber identity module (“SIM”)-based credentials are supported for the NSWO procedure. In various embodiments, a device can use either SIM-based credentials or non-SIM based credentials (e.g., ID and credentials stored in a mobile equipment (“ME”)) associated with the corresponding network (e.g., PLMN or SNPN) for the NSWO procedure.

The system of FIG. 5 may apply to various embodiments described herein. Specifically, FIG. 5 shows a SNPN where the UE's credentials are stored; however, it is possible that the UE's credentials are stored in a PLMN. Further, the services accessed by the UE may be in a SNPN and/or PLMN different from the SNPN and/or PLMN where the credentials are stored. In other words, the DNNs to which the UE is allowed to access can be located in a different network (e.g., SNPN and/or PLMN) from the network where the credentials are stored. In such case, the NF, which determines the allowed and/or restricted destination routes for the UE (e.g., the NSWOF) may in addition receive information (e.g., from a UDM) about a target network ID (e.g., SNPN ID or PLMN ID) associated with the allowed list of service IDs or DNNs.

In a first embodiment, there may be an independent NSWO service authorization procedure. This embodiment describes a procedure for retrieving the NSWO service restriction information independent of the procedure for NSWO authentication. The reason to propose an independent NSWO service authorization procedure is to allow the NSWOF to use different service operations (e.g., Nausf service offered by the AUSF for UE authentication and Nudm service offered by the UDM for retrieving the NSWO service restriction information (e.g., from the UE subscription data)).

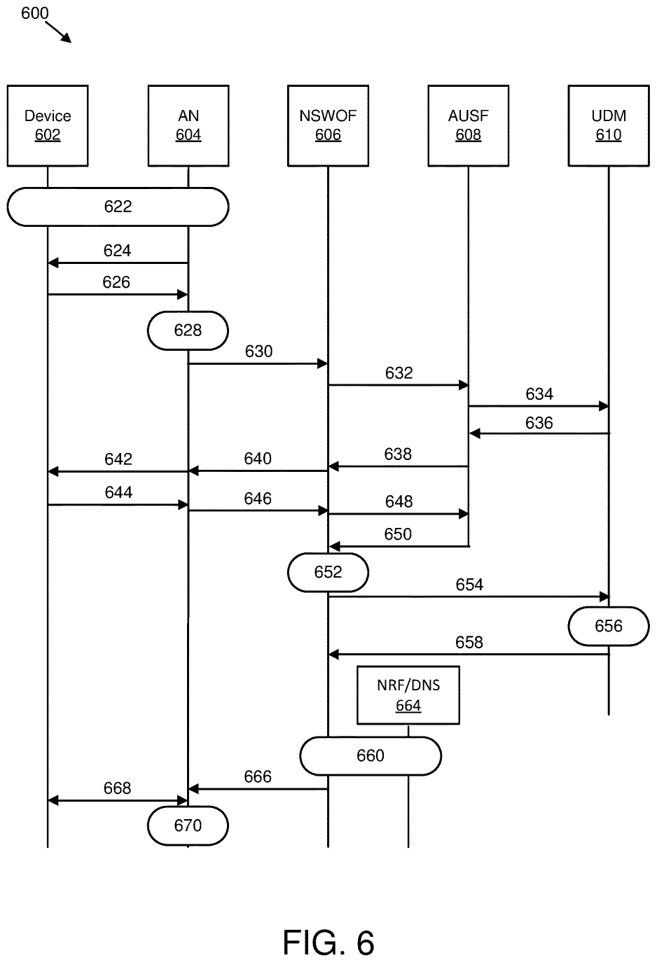

FIG. 6 is a schematic block diagram illustrating one embodiment of a system 600 having communications for NSWO service authorization information. The system 600 includes a device 602 (e.g., with an SNPN subscription), an AN 604 (e.g., WLAN), a NSWOF 606, an AUSF 608, and a UDM 610. The NSWOF 606, the AUSF 608, and the UDM 610 are part of a 5G network domain, and the AN 604 may be part of the 5G network domain. Any of the communications of the system 600 may include one or more messages.

The device 602 may implement different capabilities as described herein (e.g., may be a 3GPP device implementing N1 capability, or a device lacking N1 capability). It is however assumed that the device 602 stores IDs and credentials in the networks subscriber repository, wherein such credentials are referred as an SNPN subscription.

In a first communication 622, the device 602 discovers an access network and attempts to establish a connection with the AN 604 (e.g., via a layer 1 (“L1”) and/or layer 2 (“L2”) connection).

In a second communication 624, the AN 604 may initiate an authentication and/or authorization procedure by transmitting an extensible authentication protocol (“EAP”) request and/or identity request message.

In a third communication 626, the device 602 sends to the AN 604 a EAP response and/or identity reply message which may include the device 602 and/or subscriber ID in the form of network access identifier (“NAI”)-based subscription concealed identifier (“SUCI”) (e.g., concealed “username@realm”). The SUCI is derived from a subscription permanent identifier (“SUPI”) (e.g., the SUCI contains the concealed SUPI).

The device 602 derives the identifier as SUCI in NAI format (e.g., username@realm format) as its identity irrespective of whether a SUPI type configured on the universal SIM (“USIM”) or ME is in the form of international mobile subscriber identity (“IMSI”)-based format or NAI-based format.

In addition, the provided SUCI (e.g., in NAI format) may be decorated (e.g., the identifier is formatted in an enhanced manner to include additional information like service ID) to provide a service ID which the device 602 wants to use. The UE generates the decorated SUCI based on request from higher layers (e.g., from the application layer) wherein the requesting application is associated with a service ID. The network (e.g., one of AN, NSWOF, or UDM) may use the decorated SUCI to identify the (1) subscriber and (2) the service which the subscriber wants to use. The network may perform the authentication and/or authorization procedure for the device 602 or for the device 602 and requested service. One example of decorated SUCI (or decorated NAI) provided by the UE including a service and the SUCI is: <service_ID>! type1.rid678.schid1.hnkey27.ecckey<ECC ephemeral public key>. cip<encryption of user17>.mac<MAC tag value>@example.com, where the service_ID could be “enterprise ID”, “ims”, “internet”, or anything similar to a data network name or service identifier.

The AN 604 continues 628 with the authentication and/or authorization procedure towards the NSWOF 606 using the SWa interface. Based on the “realm” part of the device ID, the AN 604 may optionally determine to request NSWO service authorization parameters. For example, the AN determines to request the NSWO service authorization (or restriction) if the “realm” part of the device ID is the same as the NSWOF's realm part.

It is assumed that the AN 604 stores information about the NSWOF identification information (e.g., NSWOF ID in form of URI) so that the AN 604 can deduce the domain name to which the NSWOF belongs.

In a fourth communication 630, the AN 604 sends to the NSWOF 606 an authentication request using the SWa interface. The AN 604 includes the EAP response from the AN (e.g., SUCI) and optionally it may include an indication ‘NSWO service authorization’, which may have one or more meanings: 1) the AN 604 implements the capability to receive and resolve service ID or DNN-the AN indicates this particular support to the NSWOF 606; and/or 2) the AN 604 requests the NSWO service authorization information, as the AN 604 is configured to enable access to specific network operator services (e.g., access to specific DNNs).

In a fifth communication 632, the NSWOF 606 sends to the AUSF 608 a Nausf_UEAuthentication request message including the SUCI, access network ID (e.g., AN ID), and an indication that the authentication is for NSWO (e.g., NSWO_indication). The fifth communication 632 is used to authenticate the device for NSWO access.

In a sixth communication 634, the AUSF 608 sends to the UDM 610 a Nudm UEAuthentication_Get request including the SUCI, AN ID, and NSWO indication.

In a seventh communication 636, the UE subscription data in the UDM 610 contains the authentication credentials (e.g., subscriber ID (e.g., SUPI in IMSI or NAI format)) and the authentication vector (“AV”). The subscriber ID and credentials are sent to the AUSF 608. The UMD 610 sends to the AUSF 608 a Nudm_UEAuthentication_Get response including the SUPI, and an EAP-authentication and key agreement's (“AKA's”) AV.

In an eighth communication 638, a nineth communication 640, a tenth communication 642, an eleventh communication 644, a twelfth communication 646, and a thirteenth communication 648, the AUSF 608 performs EAP and/or AKA authentication procedure with transmissions towards the device 602. This procedure includes the transmission of an EAP request and/or AKA challenge from the AUSF 608 to the NSWOF 606 included in the Nausf UEAuthentication response message. At the end of this exchange, the NSWOF 606 sends the EAP and/or AKA (e.g., challenge) to the AUSF 608. The AUSF 608 performs and/or evaluates the received credentials from the UE and determines whether the EAP and/or AKA procedure is successful or failed.

In a fourteenth communication 650, the AUSF 608 sends to the NSWOF 606 a Nausf UEAuthentication response including the EAP result (e.g., success or failure), and, in case of success, a master session key (“MSK”), subscriber ID (e.g., SUPI) of the device, and so forth.

The NSWOF 606 triggers NSWO a service authorization procedure to identify the services (or other parameters) to which the UE is subscribed.

After the successful authentication, the NSWOF 606 may determine 652 to store UE context (e.g., the NSWOF 606 acts as a stateful NF) and may determine to trigger the NSWO service (or routing) authorization procedure. The trigger events for the NSWO service authorization procedure may be based on one or more of the following: 1) if the AN ID is identified to be a part of the network operator (e.g., SNPN) domain, the NSWOF 606 may determine that the device 602 is able to access operator offered services; 2) if the realm of the SUPI (e.g., in case of NAI-based SUPI) is part of or the same as the network operator (e.g., SNPN) domain name, the NSWOF 606 may determine that the device 602 may be subscribed to use (or restricted to not use) specific internal or external services; 3) the NSWOF 606 may be configured by an operations and management (“OAM”) system to always perform the NSWO service authorization procedure, or to perform the NSWO service authorization procedure for a range of SUPIs; 4) the NSWOF 606 has received an indication ‘NSWO service authorization’ from the AN; and/or 5) the SUCI is decorated by a service ID-in such case, the NSWOF 606 determines to request the target destination addresses (e.g., IP address, prefix, FQDN) associated with the service ID.

In a fifteenth communication 654, the NSWOF 606 triggers the Nudm SubscriberDataManagement service to retrieve UE subscription data (e.g., more specifically the NSWOF may send a Nudm_SDM_Get request message towards the UDM 610 to retrieve the NSWO service authorization data and/or information for the device 602 (e.g., for the SUPI)). The NSWOF 606 may include a new indication that it is interested in the NSWO-related subscription data (e.g., the request is not for the whole UE subscription data, but only for a subset of the subscription data applicable to NSWO access or NSWO service authorization information). In some embodiments, the source NF ID parameter, which indicates that the requesting NF is of type NSWOF, in the request message may be used as indication to the UDM 610 that the NSWO-related subscription data is requested. In one embodiment, the NSWOF 606 may request from the UDM 610 the NSWO route authorization (or permission or restriction) information for the device's traffic.

The UDM 610 and/or UDR determines 656 the NSWO service authorization (or permission or restriction) information. The NSWO service authorization information may include a list of allowed (and/or forbidden) enterprise and/or operator's offered services, and/or a list of allowed (or forbidden) external services (e.g., offered via the Internet). The services, which the device is authorized and/or allowed to use, are services which are allowed to be used in the specific case that the device is not registered to the 5GS, but successfully registered to the AN via 5GS credentials (e.g., SNPN or PLMN credentials). The UDM 610 and/or UDR determines to provide the NSWO service authorization information by taking into consideration (a) the indication regarding the NSWO-related subscription data provided to the UDM in step 654; or (b) the type of the NF requesting the UE subscription data, wherein, in a particular example, if the type of the NF is NSWOF, the UDM determines to provide the NSWO route authorization information (or in contrary, if the type of the NF is not NSWOF, the UDM determines to not provide the NSWO route authorization information).

The following handling in the UDM 610 and/or UDR is possible:

In a first step, a new subscriber data type may be introduced which contains a list of one or more service IDs or DNNs which are allowed to be used by the subscriber when using NSWO access. For example, the name of this subscription data type can be “NSWO allowed services”, “NSWO allowed (operator) services”, or “NSWO allowed operator DNNs”. The allowed list of service IDs or DNNs correspond to network operator services (e.g., the services and/or DNNs which are controlled by the network operator or are part of the network operator's domain). The service ID or the DNN may be formatted as a fully-qualified domain name (“FQDN”), or a uniform resource locator (“URL”) (e.g., “serviceID. domain. com” where the “serviced” may be “IMS”, “mail”, or “SAP”), and the “domain” may be a company domain name (e.g., lenovo. com or siemens. com). In addition, the device 602 may be allowed to access one or more Internet services outside the network operator's control. In such case, the “NSWO allowed services” may contain a parameter indicating that access to Internet is allowed.

In a second step, the existing subscription data types (e.g., MPS, aerial, V2X, subscription types) may be used to derive corresponding service IDs or DNNs which are allowed when using NSWO access.

In a third step, the existing ‘Subscribed DNN list’ parameter may be used to derive the NSWO allowed operator DNNs. In a particular example, a single DNN (e.g., corresponding to the default DNN) may be determined to be used as allowed DNN.

In a sixteenth communication 658, the UDM 610 and/or UDR sends a Nudm SDM_Get response message containing the NSWO service authorization data and/or information. The NSWO service authorization data and/or information may include one or more of: 1) NSWO allowed operator internal DNNs and/or service IDs (or allowed destination IP addresses and/or prefixes or FQDNs); 2) NSWO forbidden operator internal DNNs and/or service IDs (or forbidden destination IP addresses and/or prefixes FQDNs); 3) NSWO allowed external DNNs and/or service IDs (e.g., services external to the network operator like Internet services); and/or 4) NSWO forbidden external DNNs and/or service IDs (e.g., services external to the network operator like Internet services). It should be noted that the list differentiates operator internal and operator external services, but in a more general case, such differentiation may not be needed and a single list of allowed and/or forbidden DNNs and/or service IDs (or allowed destination IP addresses and/or prefixes or FQDNs) may be transmitted.

In a seventeenth communication 660, the NSWOF 606 may perform a procedure to resolve the service ID or DNN to a target IP address or IP prefix (e.g., if the information received is different from the allowed destination IP addresses and/or prefixes). For example, the NSWOF 606 may interrogate with a NRF or DNS server 664 in the network operator′ domain to resolve the destination IP address, or destination IP prefix corresponding to the service ID or DNN.

If the NSWOF 606 has received from the AN 604 a capability indication that the AN 604 supports the service ID or DNN resolution, then the NSWOF 606 may omit the seventeenth communication 660 because the AN 604 can perform the resolution by itself.

In an eighteenth communication 666, the NSWOF 606 sends an authentication response to the AN 604 containing one or more of the following parameters: EAP result (e.g., success or failure), MSK, the subscriber ID (e.g., SUPI corresponding to the SUCI), and/or a list of allowed destination IP addresses or IP prefixes.

In various embodiments, if the AN 604 has indicated that it supports the feature of service ID and/or DNN resolution, the NSWOF 606 may include a new parameter service ID identifying a list of one or more allowed (or forbidden) services IDs (or DNNs or routing rules indicating how to route the device's 602 data towards target destinations). In one example, the parameter (e.g., “service IDs”) can include one list of allowed services and one list of forbidden services, which may be used in addition to the list of allowed destination IP addresses.

In a nineteenth communication 668, the AN 604 sends to the device 602 the EAP result. Following the transmission of EAP “success” result, the device 602 and AN 604 establish a secure L2 connection which is used to encrypt the data between the device 602 and the AN 604 in uplink and downlink. The AN 604 may provide a local IP address and IP configuration to the device 602.

If the AN 604 receives a list of allowed service IDs, DNNs, or routing rules (or routing restrictions), the AN 604 attempts 670 to resolve the destination IP addresses or prefixes. Based on the resolved IP addresses and/or prefixes or on the information received in step 666 about the list of allowed destination IP addresses and/or prefixes, the AN 604 may configure routing rules or routing filters (e.g., similar to firewall) for the allowed destination addresses which the device 602 is allowed to use. The AN 604 may have pre-established tunnels (e.g., IP tunnels) to route data between the AN 604 and the particular DNNs (or application servers). The DNNs may be located in the network domain or outside the network domain. The AN 604 may use such pre-established tunnels to route the device's data to the destination DNN, service, and/or IP address. The AN 604 may apply the following configuration for the device 602: 1) allow to use a specific DNN (e.g., characterized by a destination IP address internal for the operator) in the network operator's domain and Internet services (e.g., characterized by any destination IP external to the operator's domain); and 2) block the access to other DNNs in the network operator's domain.

It should be noted that a benefit of the first embodiment may be that the 5GC (e.g., NSWOF together with UDM) can provide to the AN 604 allowed service information tailored for the particular device. The allowed (or forbidden) service information may include the service IDs, DNNs or IP addresses and/or prefixes which are allowed to be used by the device 602.

In a second embodiment, an NSWO service authorization procedure may be embedded in a NSWO authentication procedure. In this embodiment, the NSWO service authorization information is retrieved during the NSWO authentication procedure. In other words, the NSWO service authorization procedure is embedded in the NSWO authentication procedure which is performed via the AUSF. This procedure can be called an enhanced NSWO authentication wherein the enhancement is to enable the transmission of NSWO service authorization information.

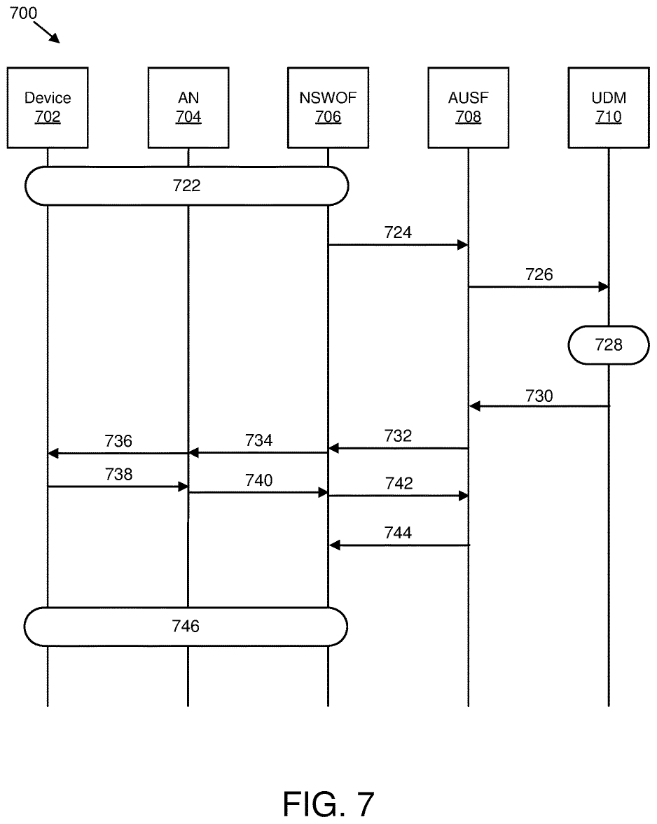

FIG. 7 is a schematic block diagram illustrating one embodiment of a system 700 having communications for NSWO service authorization information embedded in authentication signaling. The system 700 includes a device 702 (e.g., with an SNPN subscription), an AN 704 (e.g., WLAN), a NSWOF 706, an AUSF 708, and a UDM 710. The NSWOF 706, the AUSF 708, and the UDM 710 are part of a 5G network domain, and the AN 704 may be part of the 5G network domain. Any of the communications of the system 700 may include one or more messages.

In a first communication 722, steps 622 through 630 of FIG. 6 may be performed.

In a second communication 724, the NSWOF 706 sends a request for UE authentication for NSWO to the AUSF 708 via a SWa interface. The NSWOF 706 uses a Nausf UEAuthentication request message including at least parameters SUCI, AN ID, and an indication that the authentication is for NSWO (e.g., NSWO_indication) and optionally a new parameter to request an NSWO service authorization request. The NSWOF 706 determines to include (or not include) a new parameter to request NSWO service authorization information request as described in step 652 in FIG. 6. In one alternative, the NSWOF 706 may request from the UDM 710 the NSWO route authorization information for the device's traffic.

In a third communication 726, the AUSF 708 sends to the UDM 710 a Nudm_UEAuthentication_Get request including the SUCI, AN ID, and NSWO indication, and the parameter requesting NSWO service authorization request. The AUSF 708 does not process or modify the NSWO service authorization request but merely forwards the parameter to the UDM 710 as received from the NSWOF 706.

The UE subscription data in the UDM 710 contains the authentication credentials (e.g., subscriber ID (SUPI in IMSI or NAI format) and the AV as described in step 636 in FIG. 6, and, in addition, the UDM 710 may maintain 728 NSWO-related service subscription data as described in step 656 in FIG. 6.

In a fourth communication 730, the UDM 710 sends to the AUSF 708 a Nudm UEAuthentication_Get response message including the usual authentication information (e.g., SUPI, EAP-AKA's AV). In addition, the UDM 710 may provide the NSWO service authorization information in the response message to the AUSF.

The UDM 710 may determine to include the NSWO service authorization information in the response to the AUSF 708 in one of the following ways: 1) based on the indication for requesting NSWO service authorization request; or 2) based on local configuration in the UDM 710 that the NSWO service authorization information should always be provided if the authentication is via NSWO. The UDM 710 knows that the UE authentication is for NSWO based on the NSWO indication from step 726. It should be noted that the AN 704 in step 722 or the NSWOF 706 in step 724 are not required to include indication for NSWO service authorization request. The NSWO service authorization information content is described in step 658 in FIG. 6.

A fifth communication 732, a sixth communication 734, a seventh communication 736, an eighth communication 738, a nineth communication 740, and a tenth communication 742 may be substantially similar to steps 638 through 648 from FIG. 6.

In an eleventh communication 744, the AUSF 708 sends to the NSWOF 706 a Nausf_UEAuthentication response message including the EAP result (e.g., success or failure), the MSK, subscriber ID (e.g., SUPI) of the device, and, in addition, the NSWO service authorization information. The AUSF 708 does not process or modify the NSWO service authorization information but merely forwards the parameter to the NSWOF 706 as received from the UDM 710.

A twelfth communication 746 may be substantially similar to steps 660-670 from FIG. 6.

In certain embodiments, a benefit of the second embodiment may be that the 5GC NSWOF 706 retrieves (or obtains) the NSWO service authorization information during the UE authentication procedure for NSWO access.

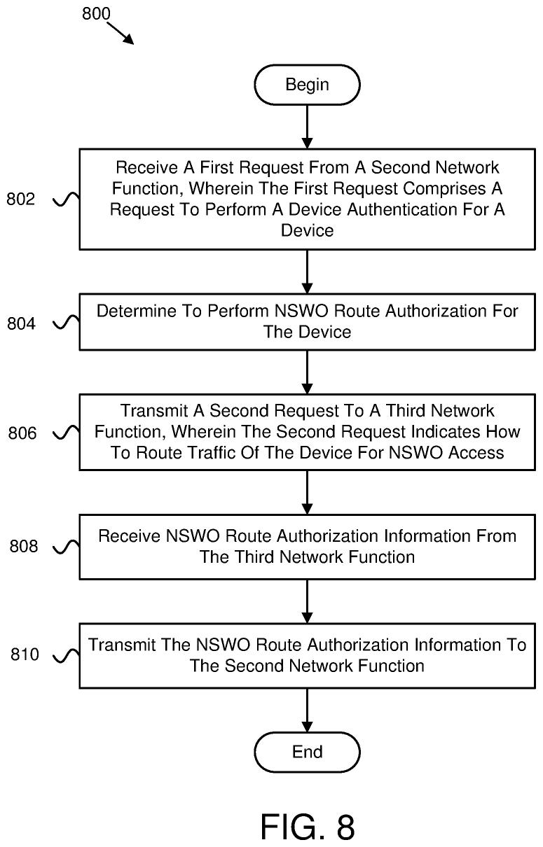

FIG. 8 is a flow chart diagram illustrating one embodiment of a method 800 for authorizing a NSWO route. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a first network function, a first request from a second network function. The first request includes a request to perform a device authentication for a device. In some embodiments, the method 800 includes determining 804 to perform NSWO route authorization for the device. In certain embodiments, the method 800 includes transmitting 806 from a second request to a third network function. The second request indicates how to route traffic of the device for NSWO access. It should be noted that the indication may also indicate which services and/or DNNs are allowed and/or forbidden when the device uses the NSWO access. In some embodiments, the method 800 includes receiving 808 NSWO route authorization information from the third network function. In various embodiments, the method 800 includes transmitting 810 the NSWO route authorization information to the second network function.

In certain embodiments, the first request comprises an indication indicating a request for NSWO route authorization. In some embodiments, determining to perform the NSWO route authorization for the device comprises determining to perform the NSWO route authorization based on: receiving an indication from the second network function; the second network function being part of a network domain to which the first network function belongs; whether a subscription identifier realm is part of the network domain; a local configuration by an operations and management (OAM) system; a subscription identifier containing a corresponding service identifier (ID); or some combination thereof. In various embodiments, the NSWO route authorization information comprises: a list of at least one service identifier; a list of at least one data network name; a list of at least one destination internet protocol (IP) address or IP prefix; or some combination thereof.

In one embodiment, the NSWO route authorization information comprises a list of allowed parameters or a list of forbidden parameters. In certain embodiments, the method 800 further comprises, prior to transmitting the NSWO route authorization information to the second network function, performing destination IP address resolution based on a list of service identifiers or a list of data network names. In some embodiments, the first network function comprises a NSWO function.

In various embodiments, the second network function comprises an access network function. In one embodiment, the third network function comprises a unified data management. In certain embodiments, the second request is transmitted to the third network function after an authentication procedure.

In some embodiments, the third network function comprises an authentication server function. In various embodiments, the second request is transmitted to the third network function as part of an authentication procedure.

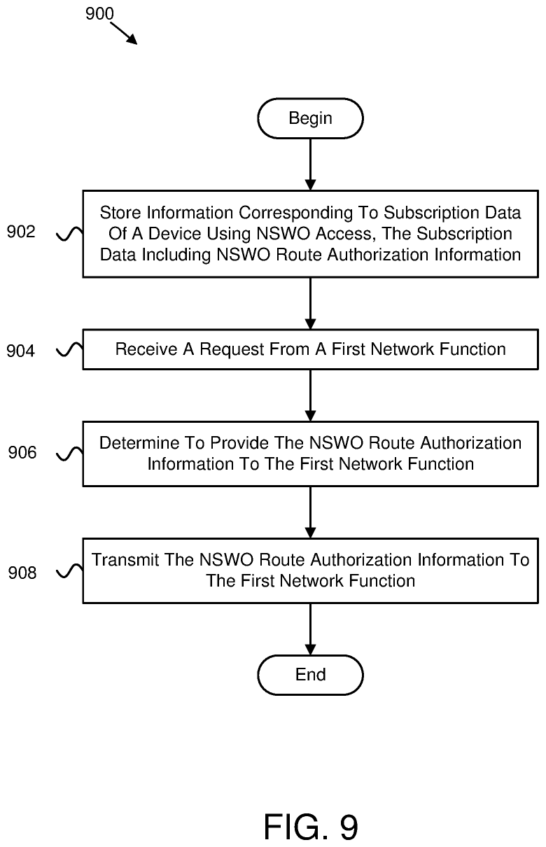

FIG. 9 is a flow chart diagram illustrating another embodiment of a method 900 for authorizing a NSWO route. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes storing 902, at a third network function, information corresponding to subscription data of a device using NSWO access, the subscription data including NSWO route authorization information. In certain embodiments, the method 900 includes receiving 904 a request from a first network function. In various embodiments, the method 900 includes determining 906 to provide the NSWO route authorization information to the first network function. In some embodiments, the method 900 includes transmitting 908 the NSWO route authorization information to the first network function.

In certain embodiments, determining to provide the NSWO route authorization information to the first network function comprises determining to provide the NSWO route authorization information to the first network function based on: the request received from the first network function indicating how to route traffic of a device for NSWO access; the type of the first network function, wherein, if the type is a NSWO function, the third network function provides the NSWO route authorization information; or a combination thereof. In some embodiments, the NSWO route authorization information comprises: a list of at least one service identifier; a list of at least one data network name; a list of at least one destination IP address or IP prefix; or some combination thereof. In various embodiments, the NSWO route authorization information comprises a list of allowed parameters or a list of forbidden parameters.

In one embodiment, the first network function comprises a NSWO function. In certain embodiments, the first network function comprises an authentication server function. In some embodiments, the third network function comprises a unified data management.

In various embodiments, the request is received by the third network function after an authentication procedure. In one embodiment, the request is received by the third network function as part of an authentication procedure.

In one embodiment, an apparatus comprises a first network function, the apparatus further comprises: a receiver to receive a first request from a second network function, wherein the first request comprises a request to perform a device authentication for a device; a processor to determine to perform NSWO route authorization for the device; and a transmitter to transmit a second request to a third network function, wherein the second request indicates how to route traffic of the device for NSWO access, wherein the receiver further to receive NSWO route authorization information from the third network function, and the transmitter further to transmit the NSWO route authorization information to the second network function.

In certain embodiments, the first request comprises an indication indicating a request for NSWO route authorization.

In some embodiments, the processor to determine to perform the NSWO route authorization for the device comprises the processor to determine to perform the NSWO route authorization based on: receiving an indication from the second network function; the second network function being part of a network domain to which the first network function belongs; whether a subscription identifier realm is part of the network domain; a local configuration by an operations and management (OAM) system; a subscription identifier containing a corresponding service identifier (ID); or some combination thereof.

In various embodiments, the NSWO route authorization information comprises: a list of at least one service identifier; a list of at least one data network name; a list of at least one destination internet protocol (IP) address or IP prefix; or some combination thereof.

In one embodiment, the NSWO route authorization information comprises a list of allowed parameters or a list of forbidden parameters.

In certain embodiments, the processor further to, prior to transmitting the NSWO route authorization information to the second network function, perform destination IP address resolution based on a list of service identifiers or a list of data network names.

In some embodiments, the first network function comprises a NSWO function.

In various embodiments, the second network function comprises an access network function.

In one embodiment, the third network function comprises a unified data management.

In certain embodiments, the second request is transmitted to the third network function after an authentication procedure.

In some embodiments, the third network function comprises an authentication server function.

In various embodiments, the second request is transmitted to the third network function as part of an authentication procedure.

In one embodiment, a method of a first network function, the method comprises: receiving a first request from a second network function, wherein the first request comprises a request to perform a device authentication for a device; determining to perform NSWO route authorization for the device; transmitting a second request to a third network function, wherein the second request indicates how to route traffic of the device for NSWO access; receiving NSWO route authorization information from the third network function; and transmitting the NSWO route authorization information to the second network function.

In certain embodiments, the first request comprises an indication indicating a request for NSWO route authorization.

In some embodiments, determining to perform the NSWO route authorization for the device comprises determining to perform the NSWO route authorization based on: receiving an indication from the second network function; the second network function being part of a network domain to which the first network function belongs; whether a subscription identifier realm is part of the network domain; a local configuration by an operations and management (OAM) system; a subscription identifier containing a corresponding service identifier (ID); or some combination thereof.

In various embodiments, the NSWO route authorization information comprises: a list of at least one service identifier; a list of at least one data network name; a list of at least one destination internet protocol (IP) address or IP prefix; or some combination thereof.

In one embodiment, the NSWO route authorization information comprises a list of allowed parameters or a list of forbidden parameters.

In certain embodiments, the method further comprises, prior to transmitting the NSWO route authorization information to the second network function, performing destination IP address resolution based on a list of service identifiers or a list of data network names.

In some embodiments, the first network function comprises a NSWO function.

In various embodiments, the second network function comprises an access network function.

In one embodiment, the third network function comprises a unified data management.

In certain embodiments, the second request is transmitted to the third network function after an authentication procedure.

In some embodiments, the third network function comprises an authentication server function.

In various embodiments, the second request is transmitted to the third network function as part of an authentication procedure.

In one embodiment, an apparatus comprises a third network function, the apparatus further comprises: a processor to store information corresponding to subscription data of a device using NSWO access, the subscription data including NSWO route authorization information; a receiver to receive a request from a first network function, wherein the processor further to determine to provide the NSWO route authorization information to the first network function; and a transmitter to transmit the NSWO route authorization information to the first network function.

In certain embodiments, the processor to determine to provide the NSWO route authorization information to the first network function comprises the processor to determine to provide the NSWO route authorization information to the first network function based on: the request received from the first network function indicating how to route traffic of a device for NSWO access; the type of the first network function, wherein, if the type is a NSWO function, the third network function provides the NSWO route authorization information; or a combination thereof.

In some embodiments, the NSWO route authorization information comprises: a list of at least one service identifier; a list of at least one data network name; a list of at least one destination IP address or IP prefix; or some combination thereof.

In various embodiments, the NSWO route authorization information comprises a list of allowed parameters or a list of forbidden parameters.

In one embodiment, the first network function comprises a NSWO function.

In certain embodiments, the first network function comprises an authentication server function.

In some embodiments, the third network function comprises a unified data management.

In various embodiments, the request is received by the third network function after an authentication procedure.

In one embodiment, the request is received by the third network function as part of an authentication procedure.

In one embodiment, a method of a third network function, the method comprises: storing information corresponding to subscription data of a device using NSWO access, the subscription data including NSWO route authorization information; receiving a request from a first network function; determining to provide the NSWO route authorization information to the first network function; and transmitting the NSWO route authorization information to the first network function.

In certain embodiments, determining to provide the NSWO route authorization information to the first network function comprises determining to provide the NSWO route authorization information to the first network function based on: the request received from the first network function indicating how to route traffic of a device for NSWO access; the type of the first network function, wherein, if the type is a NSWO function, the third network function provides the NSWO route authorization information; or a combination thereof.

In some embodiments, the NSWO route authorization information comprises: a list of at least one service identifier; a list of at least one data network name; a list of at least one destination IP address or IP prefix; or some combination thereof.

In various embodiments, the NSWO route authorization information comprises a list of allowed parameters or a list of forbidden parameters.

In one embodiment, the first network function comprises a NSWO function.

In certain embodiments, the first network function comprises an authentication server function.

In some embodiments, the third network function comprises a unified data management.

In various embodiments, the request is received by the third network function after an authentication procedure.

In one embodiment, the request is received by the third network function as part of an authentication procedure.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a first network function, the apparatus comprising:
at least one memory; and
at least one processor coupled with the at least one memory and configured to cause the apparatus to:
receive a first request from a second network function, wherein the first request comprises a request to perform a device authentication for a device;
determine to perform non-seamless wireless local area network offload (NSWO) route authorization for the device;
transmit a second request to a third network function, wherein the second request indicates how to route traffic of the device for NSWO access, and wherein NSWO route authorization information is received from the third network function; and
transmit the NSWO route authorization information to the second network function.

2. The apparatus of claim 1, wherein the first request comprises an indication indicating a request for NSWO route authorization.

3. The apparatus of claim 1, wherein the at least one processor is configured to cause the apparatus to determine to perform the NSWO route authorization based on:
receiving an indication from the second network function;
the second network function being part of a network domain to which the first network function belongs;
whether a subscription identifier realm is part of the network domain;
a local configuration by an operations and management (OAM) system;
a subscription identifier containing a corresponding service identifier (ID);
or a combination thereof.

4. The apparatus of claim 1, wherein the NSWO route authorization information comprises:
a list of at least one service identifier;
a list of at least one data network name;
a list of at least one destination internet protocol (IP) address or IP prefix;
or a combination thereof.

5. The apparatus of claim 4, wherein the NSWO route authorization information comprises a list of allowed parameters or a list of forbidden parameters.

6. The apparatus of claim 1, wherein the at least one processor is configured to cause the apparatus to, prior to transmitting the NSWO route authorization information to the second network function, perform destination IP address resolution based on a list of service identifiers or a list of data network names.

7. The apparatus of claim 1, wherein the first network function comprises a NSWO function.

8. The apparatus of claim 1, wherein the second network function comprises an access network function (ANF).

9. The apparatus of claim 1, wherein the third network function comprises a unified data management (UDM).

10. The apparatus of claim 9, wherein the second request is transmitted to the third network function after an authentication procedure.

11. The apparatus of claim 1, wherein the third network function comprises an authentication server function (ASF).

12. The apparatus of claim 11, wherein the second request is transmitted to the third network function as part of an authentication procedure.

13. A method of performing a first network function, the method comprising:
receiving a first request from a second network function, wherein the first request comprises a request to perform a device authentication for a device;
determining to perform non-seamless wireless local area network offload (NSWO) route authorization for the device;
transmitting a second request to a third network function, wherein the second request indicates how to route traffic of the device for NSWO access;
receiving NSWO route authorization information from the third network function; and
transmitting the NSWO route authorization information to the second network function.

14. An apparatus for performing a third network function, the apparatus comprising:
at least one memory; and
at least one processor coupled with the at least one memory and configured to cause the apparatus to:
store information corresponding to subscription data of a device using non-seamless wireless local area network offload (NSWO) access, the subscription data including NSWO route authorization information;
receive a request from a first network function, wherein the processor further to determine to provide the NSWO route authorization information to the first network function; and
transmit the NSWO route authorization information to the first network function.

15. The apparatus of claim 14, wherein the at least one processor is configured to cause the apparatus to determine to provide the NSWO route authorization information to the first network function based on:
the request received from the first network function indicating how to route traffic of a device for NSWO access;
a type of the first network function, wherein, if the type is a NSWO function, the third network function provides the NSWO route authorization information;
or a combination thereof.

16. A method of performing a third network function, the method comprising:
storing information corresponding to subscription data of a device using non-seamless wireless local area network offload (NSWO) access, the subscription data including NSWO route authorization information;
receiving a request from a first network function;
determining to provide the NSWO route authorization information to the first network function; and
transmitting the NSWO route authorization information to the first network function.

17. The method of claim 16, wherein determining to provide the NSWO route authorization information to the first network function comprises determining to provide the NSWO route authorization information to the first network function based on:
the request received from the first network function indicating how to route traffic of a device for NSWO access;
a type of the first network function, wherein, if the type is a NSWO function, the third network function provides the NSWO route authorization information;
or a combination thereof.

18. The method of claim 16, wherein the NSWO route authorization information comprises:
a list of at least one service identifier;
a list of at least one data network name;
a list of at least one destination IP address or IP prefix;
or a combination thereof.

19. The method of claim 16, wherein the NSWO route authorization information comprises a list of allowed parameters or a list of forbidden parameters.

20. The method of claim 16, wherein the first network function comprises a NSWO function.
